(19) United States
(12) Patent Application Publication
(10) Pub. No.: US 2022/0090711 A1
(43) Pub. Date: Mar. 24, 2022

(54) SYSTEM AND METHOD FOR MANUFACTURING PIPES

(71) Applicant: TRANSCANADA PIPELINES LIMITED, Calgary (CA)

(72) Inventor: Yaokong ZHOU, Calgary (CA)

(21) Appl. No.: 17/480,689

(22) Filed: Sep. 21, 2021

Related U.S. Application Data
(60) Provisional application No. 63/081,039, filed on Sep. 21, 2020.

(51) Int. Cl. F16L 13/02

(52) U.S. Cl. CPC F16L 13/02

(57) ABSTRACT

An improved approach for welding a pipe, the pipe comprising first and second tubular sections welded to each other along a welding groove having an open-ended profile which is circumferentially extended around a pipe axis. The welding groove is formed between first and second axial edges and includes a root formed at a radially inner end of the welding groove and a portion of the welding groove radially outward relative to a root. The root axially spaces the first tubular section apart from the second tubular section substantially between 1 mm and 6 mm and the first and second axial edges are angled substantially between 6-20° (or 6-30°) away from each other radially outwardly to form the portion. The root can receive a first welding bead to fill the root and create a joint between the first and second tubular sections and additional welding beads may be utilized.

### CROSS REFERENCE

This application is a non-provisional of, and claims all benefit to, including priority from, U.S. Application No. 63/081,039, entitled: SYSTEM AND METHOD FOR MANUFACTURING PIPES, filed Sep. 21, 2020, incorporated herein by reference in its entirety.

### FIELD

This application relates to manufacturing pipes, and in particular, to welding joints used in oil and gas transmission pipelines, joining two tubular sections together using a specific welding sequence and/or joint preparation.

### INTRODUCTION

In manufacturing pipes and pipelines, e.g. for the oil & gas industry, separate tubular sections, such as pipes, components (e.g. elbows, tees, flange valves), and/or adapters, are joined together by butt welding complementary axial ends of the tubular sections.

Butt welding in pipes involves forming a welding groove between two tubular sections that are to be joined. The welding groove may take on a variety of shapes, e.g. V-shape, single-bevel, U-shaped, compound bevel, or other forms. Welding grooves are typically classed either as open-ended welding grooves or closed-ended welding grooves, also known as zero gap welding grooves, where the two tubular sections touch each other at a radially inner end of the welding groove prior to forming a weld therein. Welds may be full penetration, i.e. they may penetrate radially across a thickness of a wall the pipe (walls of the separate tubular sections). Both open-ended and closed-ended welding grooves may be configured to facilitate full penetration welds.

Butt welding is carried out using methods such as gas metal arc welding (GMAW), shielded metal arc welding (SMAW), flux-cored arc welding (FCAW), metal-cored arc welding (MCAW), or gas tungsten arc welding (GTAW). Typically, the welding method comprises two basic parts: applying heat, and depositing relatively fluid weld material (filler material), e.g. molten weld material, into the welding groove. Welding may be fusion welding. In some cases, autogenous welding may be used. Autogenous welding refers to welding where the filler material is supplied by melting the base material, or is provided exogenously but is of similar composition as the base material. Weld material is deposited in the welding groove in the form of a welding bead, which refers generally to a weld formed by a single welding pass (continuously or discontinuously passed). Multiple passes may be used to fill a welding groove. The welding process may modify the welding groove.

The quality and performance of a weld (joint) is dependent on several interrelated factors, including details of the welding process (including heat input), weld materials chosen, and details of the welding groove itself. Shielding gas may also be used to protect the weld. Flux may also be used for such purposes (e.g. from the core of an electrode). In practical applications, weld quality is critical for pipeline safety and compliance. Meeting stringent weld quality requirements may be difficult and costly.

In some cases, a backing is needed. For example a backing may be fastened, internally clamped (copper plates may be used as backing), or tack welded using gas metal arc welding. Attaching a backing requires approaching the welding groove from a radially inner end of the pipe, which may (in various cases) be costly, difficult and time-consuming. Furthermore, the backing does not normally form part of the weld or joint and thus needs to be removed after welding, thereby increasing time and labor requirements. The addition of backing to the welding process can considerably increase time and cost of the weld. Additionally, specialized equipment may be required.

Quality control is required to ensure welds meeting standards, e.g. cleaning and grinding requirements between welding passes. Welding consumables such as flux generally reduce productivity but are nonetheless required to protect the weld. Welding groove designs and welding processes must pass stringent tests to comply with regulatory requirements (e.g. integrity management). This is particularly true for oil and gas transmission pipelines that pass through High Consequence Areas (HCAs) since weld failure may cause leakage of toxic or flammable materials. The weld itself must be inspected and repaired if necessary (repair rate). Various testing protocols include crack tip opening displacement (CTOD) tests to measure fracture toughness, and (low-temperature) Charney V-notch (CVN) tests. Cost of quality control and compliance may be high.

The design parameter space for welding joints may be large. To reduce costs and risk, in many cases, various welding processes and joint configurations are used.

### SUMMARY

An improved approach is provided herein, describing an improved approach in joint preparation and welding sequence using a narrow bevel design that uses a metal cored arc welding process or flux cored arc welding process. The improved approach may reduce or eliminate the need for a backing. Specific ranges for bevel dimensions are described herein for the narrow bevel design, and the approach may potentially yield a lower repair rate (e.g., less than 3%) relative to conventional approaches.

The size and shape of the welding groove influences the quality of the welding joint and affects the cost and time required to form the weld. Larger welding grooves require more material and a longer time for weld completion. Higher heat input applied on larger welding grooves reduces the quality of the welding joint and may negatively affect the material properties, e.g. it may lead to softening in the heat-affected zone (HAZ) of the base material.

Larger welding grooves may also lead to multiple welding beads arranged side-by-side (i.e. axially) in the same layer (i.e. same general radial location), potentially reducing the quality of the weld and introducing additional joining edges (defining inter-bead connections) which may be more prone to failure. Alternatively, wide weaving welding may be used but this may expose the base material to higher temperatures for longer to the detriment of the base material. Additionally, wider welds may also be more difficult to clean and grind, e.g. chipping slag after welding, especially regions between adjacent weld beads in the same layer. It may be easier to grind slag if each layer has one weld bead, and also reduce time and cost associated with interpass grinding. Furthermore, excessively large welds may not be amenable to fast and/or automatic non-destructive evaluation (NDE) of welds, e.g. ultrasonic or radiographic testing. Wide angle welding grooves (˜60°) are susceptible to shearing under tensile loading of the pipe.

At the same time, relatively large open-ended welding grooves to be filled from an inner wall of the pipe to an outer wall of the pipe may be desirable as they may lead to better quality welds and lower repair rates as compared to welds formed in closed-ended welding grooves or partial penetration welds. For example, a weld formed in a zero gap welding groove may lead to repair rates greater than 10%. Zero gap welding grooves may require a backing (welded backing, fastened, internally clamped, or tack welded), which is undesirable as outlined above, e.g. the welding groove then would normally need to be worked from both radial ends of the pipe wall, thereby increasing costs. Additionally, compared to larger welding grooves, smaller welding grooves may not be always be readily workable, e.g. the electrode or other welding parts may be hindered by inner or side walls of the welding groove. In some cases, welds formed in small welding grooves may lead to defects on the side walls of the welding groove and increased porosity and/or slag inclusions. A joint formed by a weld in a welding groove is proposed that has benefits in welding time and labor costs.

As described in a first embodiment, a proposed welding groove is a V-shaped welding groove defining a welding gap between two tubular sections. The root of the welding groove, can, in an aspect, be extended radially outwardly.

In a more specific embodiment, the welding groove opens radially outwardly at an angle between 6° and 20 (or 6-30°) with an open-ended (full penetration) profile terminating at a radially inner end (the root) where two opposing sides of the welding groove are spaced apart between approximately 1 mm to approximately 6 mm (the root spacing). In various embodiments, the root spacing may be between approximately 3.5 mm and approximately 6 mm. Other variations are possible.

In another embodiment, the welding groove opens instead radially outwardly at an angle between approximately 3 and approximately 10 degrees on each side (approximately 6-20 degrees to include both sides).

In various embodiments, the narrow angle of the welding groove may reduce a susceptibility of the welding groove to undergo shearing under tensile loading of the pipe, e.g. the tensile strength may be increased by 10% or more compared to a wide angle welding groove.

In various embodiments, for typical pipe wall thicknesses ranging between 6 to 50 mm, the welding groove may be filled with single welding beads layered on top of each other (radially, i.e. not adjacent in an axial direction) and may require 50-60% less heat input and welding time than a wider weld. Additionally, in various embodiments, wide weaving of welds may not be necessary, resulting in low heat input and subsequent reduction in softening in the heat affected zone (HAZ). In some embodiments, welding consumables may be reduced by 50-60%.

In various embodiments, the proposed welding groove does not require a backing (welded or otherwise) for welding, e.g. labour costs may be decreased significantly as a result (up to 50%). In various embodiments, the open-ended shape of the welding groove avoids high repair rates associated with zero gap welding grooves. In various embodiments, the welding groove reduces the risk of defects on the side walls of the welding groove, and the relative extent of porosity and/or slag inclusions. In some embodiments, the welding groove may be especially adapted to work with mechanized/automated welding, e.g. wire-based welding, but may also be used in manual welding (stick welding). Costs may be reduced and quality may be increased.

In various embodiments, no special internal equipment is needed to form the groove. The proposed joint may applicable to a wider variety of pipelines as there may be no need to work from inside the pipelines, in various embodiments. In various embodiments, engineering critical assessments (ECA) may not be necessary and low repair rates (e.g. <3%) may be achievable with workmanship acceptance criteria.

In one aspect, there is provided a method of manufacturing a pipe by joining a first tubular section to a second tubular section along a pipe axis, the first and second tubular sections having substantially similar inside and outside diameters, the method comprising: forming a weld between the first tubular section and the second tubular section by depositing weld material under heat to substantially fill a root at a radially inner end of a welding gap formed between the first tubular section and second tubular section, wherein the welding gap extends from a radially inner wall of the pipe to a radially outer wall of the pipe, the root axially spaces the first tubular section apart from the second tubular section substantially between approximately 1 mm and approximately 6 mm, and the welding gap is formed by positioning a first axial edge defined by the first tubular section axially alongside a second axial edge defined by the second tubular section, the first and second axial edges angled substantially between approximately 6°-approximately 30° away from each other radially outwardly to form a portion of the welding gap radially outward relative to the root. In another embodiment, the welding groove opens instead radially outwardly at an angle between approximately 3 and approximately 10 degrees on each side (approximately 6-20 degrees to include both sides).

In another aspect, there is provided a joint between a first tubular section and a second tubular section of a pipe, the first and second tubular sections having substantially similar inside and outside diameters, the joint comprising: a welding groove having an open-ended profile extending from a radially inner wall of the pipe to a radially outer wall of the pipe, the welding groove at least partially formed between a first axial edge defined by the first tubular section and a second axial edge defined by the second tubular section, the welding groove including a root formed at a radially inner end of the welding groove; and a portion of the welding groove radially outward relative to a root; and a welding bead filling the root between the first and second tubular sections and formed by depositing weld material in the root under heat, wherein the root is configured to, prior to formation of the welding bead, axially space the first tubular section apart from the second tubular section substantially between 1 mm and 6 mm and the first and second axial edges, prior to formation of the welding bead, are angled substantially between 6-30° (or in another embodiment, 6-20°) away from each other radially outwardly to form the portion.

In yet another aspect, there is provided a pipe assembly, comprising: a first tubular section; a second tubular section configured to couple with the first tubular section along a pipe axis; a welding groove having an open-ended profile circumferentially extended around the pipe axis and radially extended between a radially inner wall of the pipe assembly and a radially outer wall of the pipe assembly, the welding groove at least partially formed between a first axial edge defined by the first tubular section and a second axial edge defined by the second tubular section, the welding groove including a root formed at a radially inner end of the welding groove and configured to receive a welding bead filling the root between the first and second tubular sections to create a joint between the first and second tubular sections, the welding bead configured to be formed by depositing weld material in the root under heat; and a portion of the welding groove radially outward relative to a root and configured to receive one or more additional welding beads formed over the first welding bead and filling the welding groove, the one or more additional welds including a second welding bead configured to be formed over the first welding bead, wherein the root axially spaces the first tubular section apart from the second tubular section substantially between 1 mm and 6 mm and the first and second axial edges are angled substantially between 6-30° (or in another embodiment, 6-20°) away from each other radially outwardly to form the portion.

Corresponding welding devices, systems, articles of manufactures (e.g., products by process, such as pipe joins, and pipes of a pipeline joined using this approach) and methods are contemplated.

Devices for welding pipes in accordance to the methods described herein, including computer-aided design tools or computer-aided process tools are contemplated as well. These may include robotic welding systems that may be semi or fully autonomous. Joined pipelines, for example, can be used to safely convey gas, oil, water, biofuels, sewage, slurry, or fluids, among others.

In some embodiments, the steps may also be conducted by pipeline welders following a defined method or process for welding where physical materials are deposited in accordance with the embodiments described herein for establishing a physical weld/join.

As described herein, strong welds are an important factor in the safety of pipelines, and the proposed approaches are described to aid in ensuring that pipelines are a safe alternative relative to other approaches, such as road or rail transport.

### BRIEF DESCRIPTION OF THE DRAWINGS

FIG. 1A is a side elevation view of an exemplary pipe formed by welding together a plurality of tubular sections along a pipe axis;

FIG. 1B is a cross-sectional view along the cutting plane 1B-1B in FIG. 1A;

FIG. 1C is a cross-sectional view along the cutting plane 1C-1C in FIG. 1A;

FIG. 2 is a perspective view of an exemplary pipe assembly clamped to a platform;

FIG. 3A is a cross-sectional view along the cutting plane 3A-3A of FIG. 2, showing a welding groove of the exemplary pipe assembly;

FIG. 3B is a cross-sectional view of an exemplary joint formed by creating a first welding bead in a root of the welding groove of FIG. 3A;

FIG. 3C is a cross-sectional view of an exemplary joint with one or more additional welding beads formed over the first welding bead of FIG. 36;

FIG. 4A is a cross-sectional view of a prior art welding groove, including a wide groove angle;

FIG. 4B is a cross-sectional view of a prior art welding groove, including a backing;

FIG. 4C is a cross-sectional view of a prior art compound welding groove;

FIG. 5 is a cross-sectional view of an exemplary joint formed by multi-pass welding and comprising a plurality of layered welding beads of varying thicknesses;

FIG. 6 is cross-sectional view of a U-shaped welding groove, in accordance with an embodiment;

FIG. 7 is a flow chart of an exemplary method of manufacturing a pipe;

FIG. 8 is top view of a failed joint of a prior art pipe;

FIG. 9 is an exemplary Welding Procedure Specification (WPS);

FIG. 10 is an additional sheet of an exemplary WPS;

FIG. 11 is a photomacrograph of an exemplary weld cross-section, etched using a 5% Nital etchant; and

FIG. 12 is a schematic of exemplary welded pipes marked with testing positions for hardness testing, specifically Vickers 1 kg (HV1) hardness tests.

### DETAILED DESCRIPTION

Pipelines are manufactured using one or more tubular sections butt welded together at axial ends. The butt weld includes a welding groove whose shape and geometry needs to be specified as part of a welding protocol. The welding groove typically extends around the pipe circumferentially. Pipes, methods of manufacturing them, and joints to be used therein are described below. The joints can be used for a pipeline, which can be a pipe assembly, and the pipeline can convey various objects, such as gas (e.g., natural gas or natural gas liquids), oil, water, biofuels, sewage, slurry, or fluids (e.g., sewage, steam), among others.

Pipes can be above ground, buried, under the sea, and may be subject to various stresses, such as high pressure, heat, corrosive conditions, adverse environmental conditions (e.g. heat, cold, humidity, wind, impacts), etc. The examples are not limited to pipes per se, and some embodiments may be related to any welding of joints.

An improved welding approach (e.g. pipe welding) is described in various embodiments, directed to improved methods for welding, joints, corresponding apparatuses, and welded pipes. The improved approach is described with an improved welding sequence that allows a reduction in welding consumables as well as welding time, potentially reducing requirements for interpass grinding and defects. Furthermore, the improved approach may reduce or eliminate a need for wide weaving, and a faster travel speed is possible having less heat input (yielding higher impact toughness and/or higher capacity under tension load).

This improved approach is useful to establish improved welds, as pipeline safety is a paramount consideration. Pipelines are a relatively safe method of transporting materials (e.g. relative to rail or road). Safe operation of a pipeline is important to protect the public, workers, and the environment. Safe and strong welds are important as good interconnections between sections of pipes helps prevent failures. High quality welds are inspected and are scrutinized under high safety and quality assurance requirements, and may need to be checked by various non-destructive processes, such as X-rays or ultrasonic processes to verify that welds are sound and the pipeline is safe.

In various embodiments, pipes considered herein may be used to transport oil, gas, water, or industrial chemicals. In various embodiments, a pipe may be up to tens hundreds of kilometres long. One or more tubular sections of the pipe may be between 12 m and 24 m long. For example, a pipe in deployment (such as a pipeline) may comprise thousands of welds formed between various tubular sections. The pipe may have an outside diameter between 6 inches and 56 inches. In various embodiments, the tubular sections may be composed of a variety of material, e.g. steel alloys, HSLA steels, or low carbon steels. As a non-limiting illustration, tubular sections may be composed of one or more of alloys such as API 5L X100, API 5L X80, API 5L X70, API 5L X42, CSA Z245.1 Gr.241, CSA Z245.1 Gr.386, CSA Z245.1 Gr.414, CSA Z245, 1 Gr.448, CSA Z245.1 Gr.483, CSA Z245.1 Gr.550, and CSA Z245.1 Gr.690.

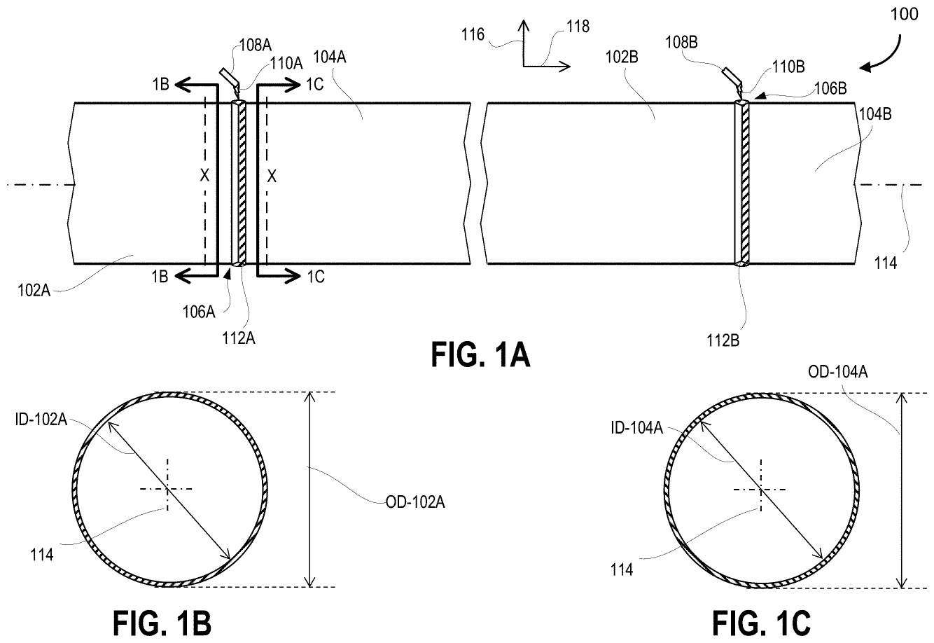

FIGS. 1A-1C are various views of an exemplary pipe 100. FIG. 1A is a side elevation view of the exemplary pipe 100 formed by welding together a plurality of tubular sections 102A, 104A, 102B, and 104B along a pipe axis 114. FIG. 1B is a cross-sectional view along the cutting plane 1B-1B in FIG. 1A. FIG. 1C is a cross-sectional view along the cutting plane 1C-1C in FIG. 1A.

In reference to FIGS. 1A-1C, the tubular sections 102A, 104A, 102B, and 104B have inside and outside diameters and may include pipes, connectors, adapters, or other tubular components that may be used to form the pipe 100. For example, the tubular section 102A may be configured to couple with the tubular section 104A along the pipe axis 114, and similarly for tubular sections 102B, 104B. As referred to herein, “tubular section” may refer to only a tubular sub-portion of a larger tubular component, e.g. construction lines marked by X in FIG. 1A illustrate a delineation of tubular sub-portions of tubular sections 102A, 104A which may each be tubular section.

The pipe axis 114 may be a local axis, e.g. the pipe 100 may include bends where a direction of the local axis changes. The pipe axis 114 defines an axial direction 118 and a radial direction 116 perpendicular thereto, e.g. by using the general geometry of the pipe to define a cylindrical coordinate system. In what follows, unless stated otherwise, radially inner or radially outer may be determined relative to the pipe axis 114. Similarly, axially may be defined relative to the pipe axis 114. It will be appreciated that a blanket implicit assumption of general (or approximate) axi-symmetry about the pipe axis 114 is not intended. However, nor is such axi-symmetry ruled out and it may be implicitly suggested solely for the sake of clarity and brevity.

The pipe 100 may be manufactured by joining the tubular sections 102A, 104A, 102B, and 104B along the pipe axis 114. For example, a joint 106A may join tubular section 102A to tubular section 104A. Similarly, a joint 106B may join tubular section 102B to tubular section 104B.

The joints 106A, 106B may be created by forming respective welds 112A, 112B (shown in partial cross-section) between, respectively, the tubular sections 102A, 104A and the tubular sections 102B, 104B.

The shape of the tubular section 102A may be complementary to the shape of the tubular section 104A to facilitate coupling and welding, e.g. proximal to the weld 112A, the inside diameter ID-102A of tubular section 102A may be substantially similar to the inside diameter ID-104A of the tubular section 104A and the outside diameter OD-102A of the tubular section 102A may substantially similar to the outside diameter OD-104A of the tubular section 104A.

Each of the respective welds 112A, 112B may be formed by depositing weld material under heat to substantially fill a (welding) gap defined by a welding groove and formed between, respectively, the tubular sections 102A, 104A and the tubular sections 102B, 104B. Arc welding may be used to fill a welding gap of the welding groove and form the welds 112A, 112B. For example, electrodes 108A, 108B may be used to generate respective arcs 110A, 110B. The arcs 110A, 110B may then generate heat necessary for forming the respective welds 112A, 112B. In various embodiments, the electrodes 108A, 108B may be consumable electrodes generating the weld material to be deposited inside the welding groove. For example, the electrodes 108A, 108B may be metal-cored electrodes, flux-cored electrode, and shielded electrodes. In various embodiments, electrodes may be in the form of wire or sticks. In various embodiments, additional shielding gas may be provided to protect weld integrity.

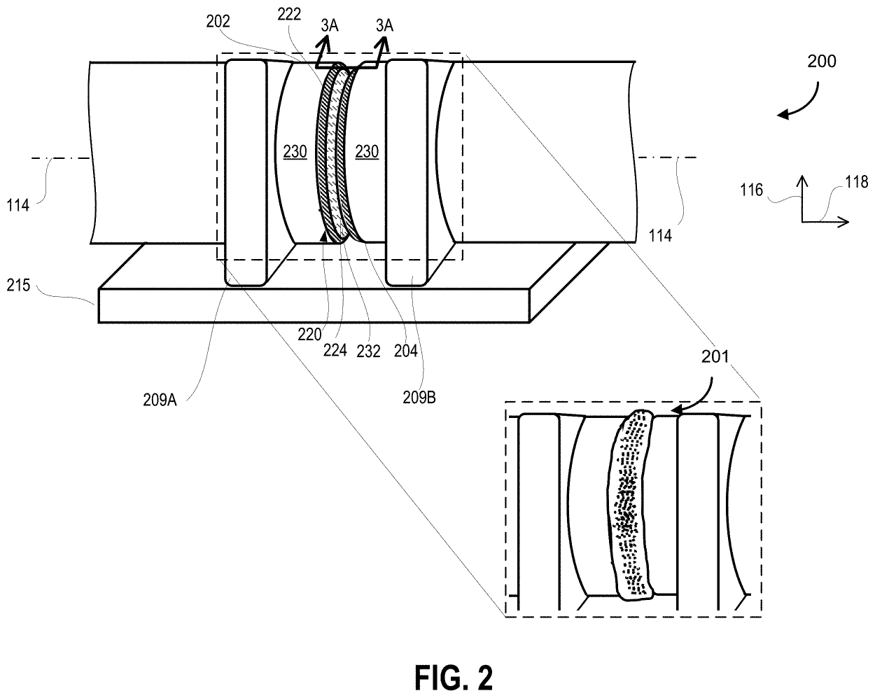

FIG. 2 is a perspective view of an exemplary pipe assembly 200 clamped to a platform 215, e.g. a workbench, using clamps 209A, 209B. The pipe assembly 200 includes a first tubular section 202 and a second tubular section 204, e.g. having substantially similar inside and outside diameters. The pipe assembly 200 may be an unwelded or partially welded pipe, i.e. the first and second tubular sections 202 may be in position, or positioned, to be fully welded or otherwise joined together along the pipe axis 114. In some embodiments, clamps 209A, 209B may not be used but instead a spacer may be placed in between the tubular sections 202, 204. In some embodiments, tack welds may be used. For illustrative purposes, the axial spacing between the first and second tubular sections 202 and 204 is rendered in an exaggerated manner. The inset in FIG. 2 shows the pipe 201 formed after welding together the first and second tubular sections 202.

The pipe assembly 200 may include a welding groove 220 circumferentially extended around the pipe axis 114 between the first tubular section 202 and the second tubular section 204. The welding groove 220 may be radially extended between a radially inner wall 232 of the pipe assembly 200 and a radially outer wall 232 of the pipe assembly 200. The welding groove 220 is at least partially formed between a first axial edge 222 defined by the first tubular section 202 and a second axial edge 224 defined by the second tubular section 204. The first axial edge 222 extends circumferentially along the first tubular section 202 around the pipe axis 114 and the second axial edge 224 extends circumferentially along the second tubular section 204 around the pipe axis 114 such that the welding groove 220 extends circumferentially around the pipe axis 114.

The welding groove 220 may having an open-ended profile (while the welding groove 220 itself may not be considered open-ended after it is filled with weld material, the profile may still be referred to as open-ended), i.e. the welding groove 220 may extend from a radially outer wall 230 to a radially inner wall 232 (of the pipe assembly 200 and/or the pipe 201).

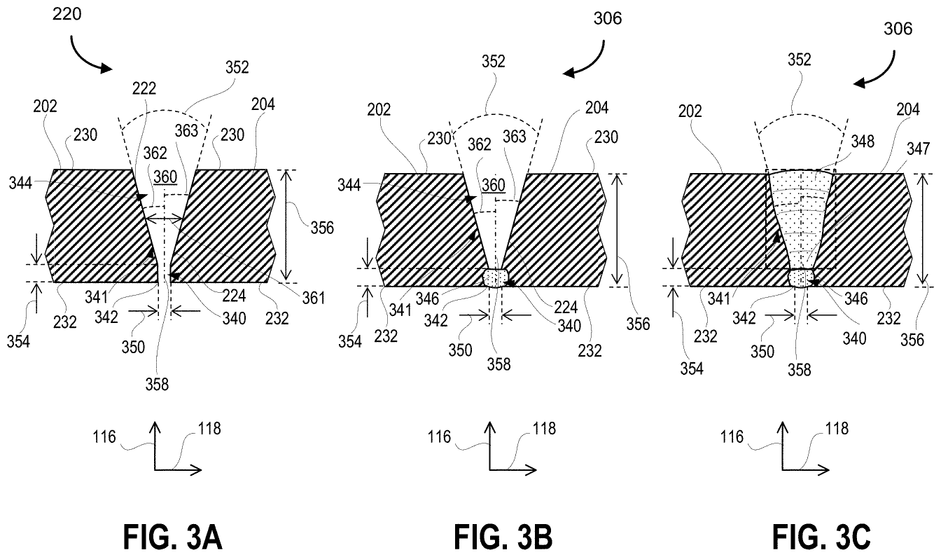

FIG. 3A is a cross-sectional view along the cutting plane 3A-3A of FIG. 2, showing the welding groove 220 of the exemplary pipe assembly 200.

FIG. 3B is a cross-sectional view of an exemplary joint 306 formed by creating a first welding bead 346 in a root 340 of the welding groove 220 of FIG. 3A.

The welding groove 220 may be a V-shaped welding groove. Such a V-shaped welding groove 220 may be machined and formed, e.g. a torch used for arc welding may be used to make bevels forming the V-shaped welding groove. When a torch is used, the groove may have an asymmetric profile and have a greater relative variation. The exemplary geometry and dimensions described herein are intended to be understood in the context of the methods and materials used to form the welding groove. In some embodiments, the welding groove 220 may be a U-shaped welding groove (as described later).

As shown in FIGS. 3A-3B, the welding groove 220 defines a welding gap 360 formed between the first tubular section 202 and second tubular section 204, which may be then filled with welding bead(s) or weld material. The welding gap 360 may be formed by positioning the first axial edge 222 axially (i.e. in the axial direction 118) alongside the second axial edge 224, e.g. by use of a spacer and/or clamps 209A, 209B.

FIG. 3C is a cross-sectional view of an exemplary joint 306 with one or more additional welding beads 348 formed over the first welding bead 346 of FIG. 3B.

In reference to FIGS. 3A-3C, the root 340 is formed at a radially inner end 342 of the welding groove 220. A portion 344 (in FIGS. 3A-3B and left unlabeled in FIG. 3C for clarity) of the welding groove 220 is formed radially outward relative to the root 340. The root 340 and portion 344 may be delineated by the open-ended profile 341 extending from a radially inner wall 232 of the pipe to a radially outer wall 230 of the pipe. The profile 341 defines the outer contours of the welding groove 220, even though the welding groove 220 may be modified by the welding process.

As shown in FIG. 3B, the root 340 is configured to receive a (first) welding bead 346 filling the root 340 between the first and second tubular sections 202, 204 to create a joint 306 between the first and second tubular sections 202, 204.

As shown in FIG. 3A, the root 340 may be configured to (at least prior to formation of the first welding bead 346) axially space (i.e. in the axial direction 118) the first tubular section 202 apart from the second tubular section 204 substantially between 1 mm and 6 mm (spacing 350 in FIG. 3A).

For example, in some embodiments, depending on the welding process (flux-cored arc welding or metal-cored arc welding), the spacing 350 may be between 3.5 mm to 6.0 mm. In some embodiments, the spacing 350 may be less than 4 mm. When the spacing 350 is greater than 6 mm, the choice of welding method may be limited. The first axial edge 222 and the second axial edge 224 (at least prior to formation of the first welding bead 346 or the one or more additional welding beads 348) are angled substantially between 6-30° (or, in another embodiment, 6-20°) (angle 352 in FIGS. 3A-3B) away from each other radially outwardly to form the portion 344, i.e. the angled axial edges 222, 224 expand or open radially outwardly. As an example, tolerances on angles referenced herein may be ±2.5°. In another embodiment, the welding groove opens instead radially outwardly at an angle between approximately 3 and approximately 10 degrees on each side (approximately 6-20 degrees to include both sides).

In various embodiments, the welding groove 220 (V-shaped, U-shaped, or other shapes) has a radially outer opening of axial width between 6 mm and 12.7 mm, i.e. the welding groove 220 at a radially outer end spaces the first tubular section 202 from the second tubular section 204 between substantially 6 mm and 12.7 mm.

In some embodiments, the root 340 (at least prior to formation of the first welding bead 346) may radially extend less than 3 mm (length 354 in FIG. 3A) from a radially inner wall 232.

In some embodiments, a radial length 356 of the welding groove 220 or welding gap 350 is substantially between 6 mm and 50 mm. For example, the radial length 356 may correspond to a pipe wall thickness.

In some embodiments, a centerline 358 of the welding gap 360 extends radially through the root 340, the first axial edge 222 is a first beveled edge angled between 3-15° (angle 362 in FIGS. 3A-3B) relative to the centerline 358 and the second axial edge 224 is a second beveled edge between 3-15° (angle 363 in FIGS. 3A-3B) relative to the centerline 358. In another embodiment, the welding groove opens instead radially outwardly at an angle between approximately 3 and approximately 10 degrees (3°-10°) on each side (approximately 6-20 degrees to include both sides).

A weld (the first welding bead 346, e.g. formed by arc welding) may be formed between the first tubular section 202 and the second tubular section 204 by depositing weld material (material forming the welding bead 346) under heat (such as that generated by the arc 110A or 110B) to substantially fill the root 340 at the radially inner (relative to the pipe axis 114) end 342 of the welding gap 360.

The first welding bead 346 may fill the root 340 between the first and second tubular sections 202, 204. The geometry of the welding groove 220 allows formation of a joint 306 without needing or using a weld backing at a radial opening (e.g. at the radially inner end 342) of the welding groove 220, such as at radially inner end 342, defined by the welding gap. Thus, the welding groove 220 and joint 306 may be substantially free from a weld backing. The welding method used may be an arc welding method, e.g. a method where the electrode itself is consumable and comprises the weld material.

The one or more additional welding beads 348 are formed over the first welding bead 346, including a second welding bead 347 formed over the first welding bead 346.

The one or more additional welding beads 348 may fill the welding groove 220. Each of the one or more additional welds 348 may extend circumferentially around the welding gap 360 and axially in the welding gap 360 from the first tubular section 202 to the second tubular section 204.

The narrow geometry of the welding groove 220 may allow only a single bead across the width of the welding gap 360 (but multiple beads may be layered on top of each other normal to the width). Thus, each of the one or more additional welds 348 may be a single bead weld extending axially in the welding gap 360 from the first tubular section 202 to the second tubular section 204.

An axial width 361 of the welding groove 220 spacing the first tubular section 202 from the second tubular section 204 may be non-decreasing radially outwardly from the root 340, i.e. the welding groove is expanding or at least non-constricting from the root 340 outwardly to the radially outer wall 230.

The weld material may include flux cored wire, metal cored wire, solid wire or/and shielded metal arc welding rods. The weld material may be deposited into the root 340 of the welding gap 360 from a consumable electrode (electrodes 108A-108B).

In various embodiments, the electrode diameter may be 4.8 mm, 2.4 mm, 3.2 mm, 1.2 mm, 1 mm, or 0.9 mm. For example a 4 mm electrode may be used for shielded metal arc welding, 2.4-3.2 mm for thin-wall shielded metal arc welding, or 0.9-1.2 mm wire for gas metal arc welding, flux core arc welding, and metal-cored arc welding.

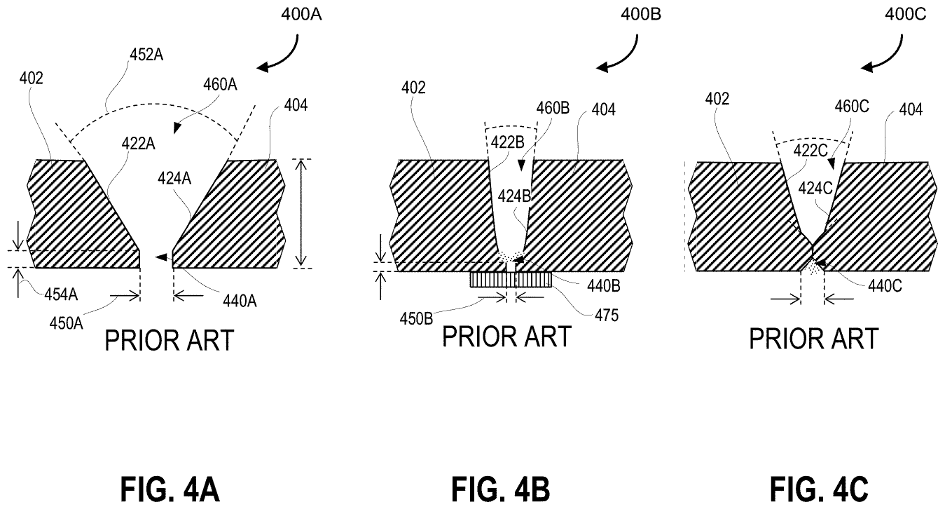

FIG. 4A is a cross-sectional view of a prior art welding groove 400A, including a wide angle welding gap 460A having a wide welding groove angle. The welding groove 400A is a V-shaped beveled groove formed from two beveled edges 422A, 424A defined by respective tubular components 402, 404. The angle 452A is about 60-80°, and the root 440A is wide, i.e. the width 450A may be between 0.8 mm to 4 mm. The root extends between 0.8 mm to 2.4 mm from the radially inner wall of the pipe (length 454A).

Potential drawbacks in such geometries necessitate multiple welding beads in the axial direction, increase in welding wire consumption and welding time, higher heat requirements (causing softening in the HAZ or reduction in impact toughness), interpass cleaning and grinding, and higher chance of forming welding defects. Some of these effects are interrelated.

The larger geometry may call for wide weaving welding, which is generally slower and thus exposes the base material to higher temperatures for longer, thereby leading to softening of the underlying material.

The larger bevel angle results in pipeline failure under high tension stress (for ductile materials, failure may occur at 45° to the pipe surface).

Pipeline failure is undesirable and an improved approach would be beneficial.

FIG. 4B is a cross-sectional view of a prior art welding groove 400B, including a welding gap 460B and backing 475. The welding groove 400B is a U-shaped groove formed from two curved edges 422B, 424B. The root 440A is narrow, i.e. the width 450A may be less than 1 mm.

Such a geometry necessitates the use of a backing, which significantly increases costs.

The backing 475 requires approaching the welding groove from a radially inner end, which may need special internal welding machines or special copper backing, and access to inside of pipe is not possible for tie-ins welds.

The repair rate of resulting welds may also be very high as the root pass may have significant quality issues, e.g. such as incomplete penetration and copper contamination.

FIG. 4C is a cross-sectional view of a prior art welding groove 4000, including welding gap 460C. The welding groove 4000 is a compound groove (composed of multiple bevels) formed by the two edges 422C, 424C which are touching (zero gap) at an intermediate position above the root 440C. Special beveling machines may be required to make these compound grooves, which may be costly.

A tack weld filling the root 440C is used as a backing. Forming the tack weld may require use of specialized equipment, clamps, and/or increased labor. This may increase costs significantly.

Again, access to inside of pipe is not possible for tie-ins welds. The welding process is typically GMAW. Lack of fusion and low weld quality are common issues. Engineering critical assessments (ECA) may take a long time for such compound grooves. In lieu of an ECA, workmanship acceptance criteria may be used but at a risk of significantly higher repair rates, schedule delays, and additional costs.

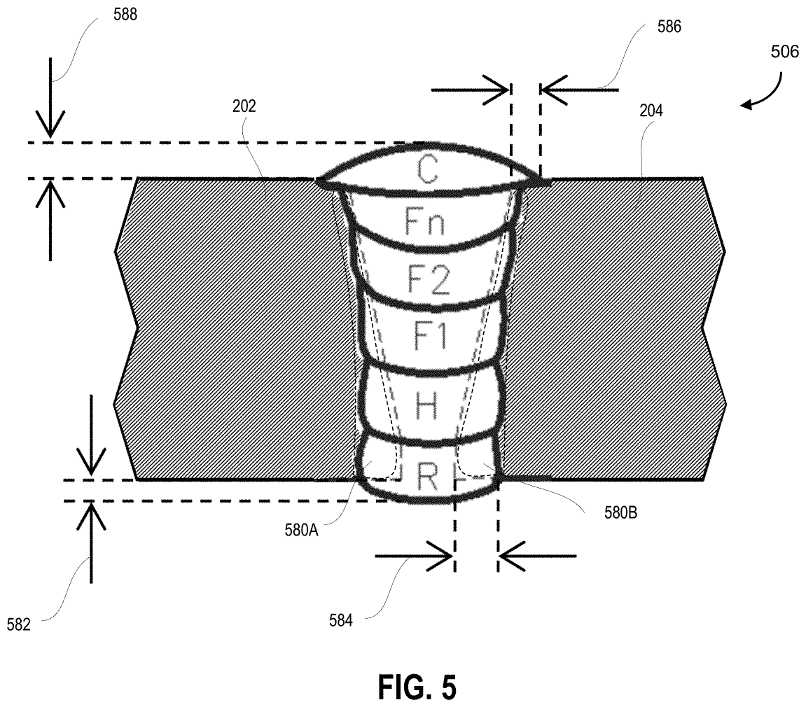

FIG. 5 is a cross-sectional view of a proposed, exemplary joint 506 between the first and second tubular sections 202, 204 formed by multi-pass welding and comprising a plurality of layered welding beads of varying thicknesses.

For clarity, parts analogous to those labelled in FIGS. 3A-3C are not indicated unless referenced. Multi-pass welding is utilized where by multiple passes/multiple layers are used to conduct the weld.

There may be synergies between passes of different layers as part of the welding process, and in some embodiments, the order or sequence in depositing weld materials in a joint design are important.

The first welding bead or first pass is labelled R, followed by the second welding bead or second/hot pass labelled H, followed by further welding beads: F1, F2, . . . , Fn, and then finally a cap welding bead labelled C.

This exemplary joint 506 is formed in accordance with steps with a method/welding process as described in various embodiments herein.

During the welding process, heat generated (e.g. from an arc) withers or erodes material away from the edges of the welding gap.

Thus, fusion zones 580A, 580B (filler penetration) form in-between the center of the welding beads and the first and second tubular sections 202, 204. For example, the fusion zones may be at least partially defined by a lengths 582, 584, 588 each less than 3 mm and the length 586 less than 4 mm.

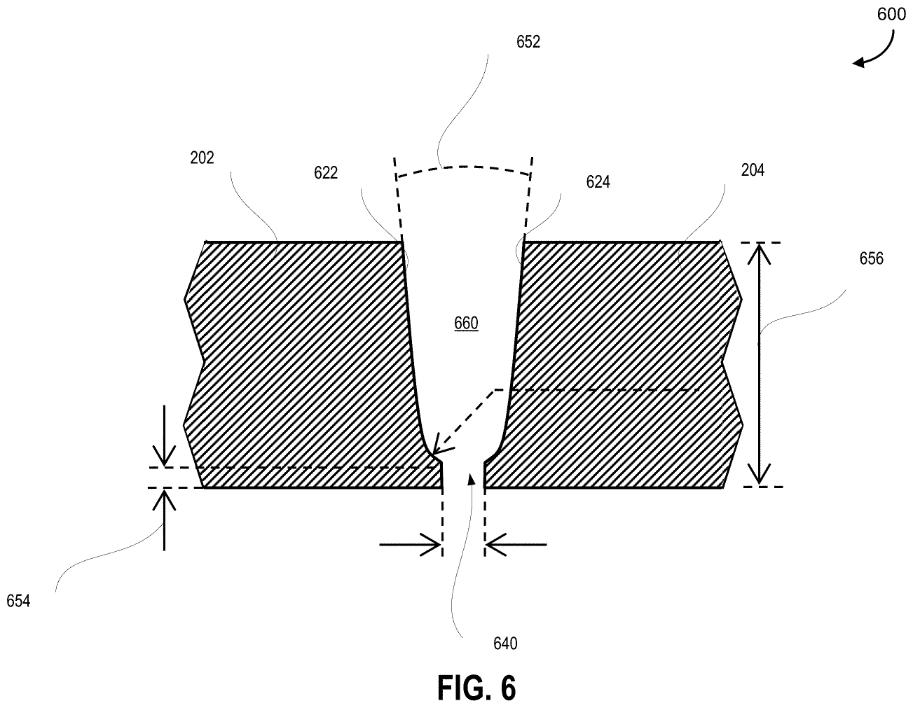

FIG. 6 is cross-sectional view of a U-shaped welding groove 600A, in accordance with an embodiment.

The welding groove 600 is defined between the first tubular section 202 and the second tubular section 204.

The axial edge 622 is angled away from the respective axial edges 624, at a radially outer end of the welding gap 660, between substantially 6-30° (angle 652). In another embodiment, in respect of angle 652 and corresponding angles 622 and 624, the welding groove opens instead radially outwardly at an angle between approximately 3 and approximately 10 degrees on each side (approximately 6-20 degrees to include both sides).

The root 640 may have a relatively narrow axial width, e.g. between 1 mm and 6 mm. In various embodiments, the axial width may be between 1 mm and 4 mm or between 3 mm and 6 mm.

For example, in various embodiments, wire welding processes may require axial widths in excess of 3 mm, 3.2 mm, or 3.5 mm. In some embodiments, wire welding processing may be more amenable to mechanization and automation. The radial extent of the gap or wall thickness 656 is between 6 mm and 50 mm. The root extends between 0.8 mm to 3 mm from the radially inner wall of the pipe (length 654). The U-shape may be defined by corners each having a radius from 2.4 mm to 4 mm.

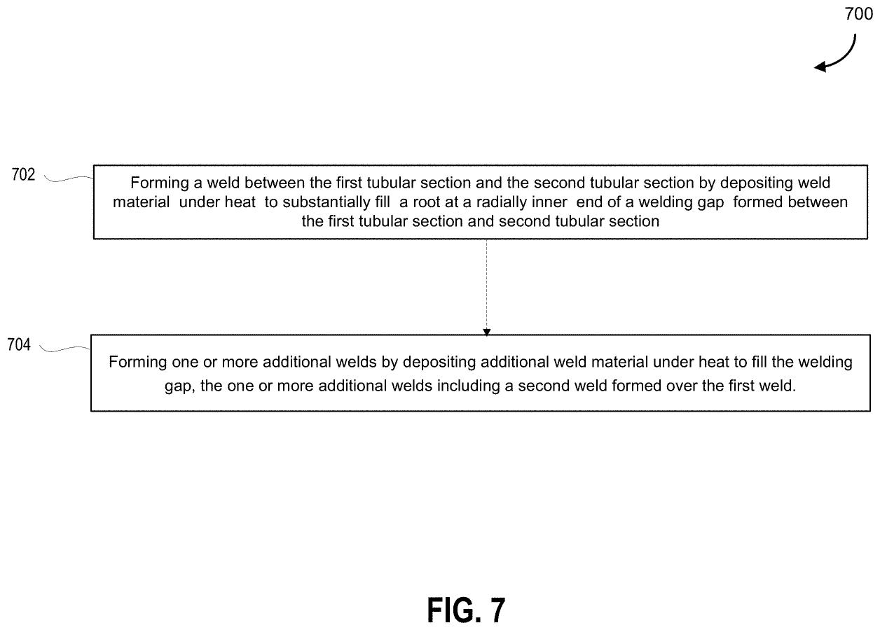

FIG. 7 is a flowchart of an exemplary method 700 of manufacturing the pipe 201 by joining the first tubular section 202 to the second tubular section 204 along the pipe axis 114, the first and second tubular sections 202, 204 having substantially similar inside and outside diameters. In various embodiments, the method 700 may be performed automatically, e.g. by use of a machine.

At step 702 of the method 700, the method includes forming a weld between the first tubular section 202 and the second tubular section 204 by depositing weld material under heat to substantially fill the root 340 at the radially inner end 342 of the welding gap 360 formed between the first tubular section 202 and second tubular section 202. The root 340 may axially space the first tubular section 202 apart from the second tubular section 204 substantially between 1 mm and 6 mm.

The welding gap 360 may be formed by positioning the first axial edge 322 defined by the first tubular section 202 axially alongside a second axial edge 324 defined by the second tubular section 204. The first and second axial edges 322, 324 may be angled substantially between 6-30° away from each other radially outwardly to form a portion of the welding gap 360 radially outward relative to the root 340. In another embodiment, the first and second axial edges are angled substantially between 6-20° away from each other radially outwardly.

The welding gap extends from a radially inner wall 232 of the pipe to a radially outer wall 230 of the pipe.

In some embodiments of the method 700, the root 340 radially extends less than 3 mm from the radially inner wall 232 of the pipe 201 or pipe assembly 200. The first 4 mm of the welding groove 220 may be subjected to different welding methods, e.g. flux core arc welding, shielded metal arc welding, and metal-cored arc welding.

In some embodiments of the method 700, the radial length 356 of the welding gap 360 is substantially between 6 mm and 50 mm.

In some embodiments of the method 700, the weld is a first weld (welding bead 346).

Some embodiments of the method 700 include a step 704, comprising: forming the one or more additional welds 348 by depositing additional weld material under heat to fill the welding gap 360, the one or more additional welds 348 including a second weld 347 formed over the first weld.

In some embodiments of the method 700, each of the one or more additional welds 348 is a single bead weld 346 extending axially in the welding gap 360 from the first tubular section 202 to the second tubular section 204.

In some embodiments of the method 700, the first axial edge 222 extends circumferentially along the first tubular section 202 around the pipe axis 114 and the second axial edge 224 extends circumferentially along the second tubular section 204 around the pipe axis 114 such the welding gap 360 extends circumferentially around the pipe axis 114 between the first and second tubular sections 202, 204, the first weld 346 and each of the one or more additional welds 348 extending circumferentially around the welding gap 360.

In some embodiments of the method 700, wherein the root 340 axially spaces the first tubular section 202 apart from the second tubular section 204 substantially between 3 mm and 6 mm.

In some embodiments of the method 700, wherein the first weld 346 is formed without using a weld backing at a radial opening (e.g. at radially inner end 342) defined by the welding gap 360.

In some embodiments of the method 700, wherein the weld material is deposited into the root 340 of the welding gap 360 from a consumable electrode.

In some embodiments of the method 700, wherein the centerline 358 of the welding gap 360 extends radially through the root 340.

The first axial edge 222 is a first beveled edge angled between 3-15° (angle 362) relative to the centerline 358 and the second axial edge 224 is a second beveled edge between 3-15° (angle 363) relative to the centerline 358. In another embodiment, the welding groove opens instead radially outwardly at an angle between approximately 3 and approximately 10 degrees on each side (approximately 6-20 degrees to include both sides). In this embodiment, the first axial edge 222 is a first beveled edge angled between 3-10° (angle 362) relative to the centerline 358 and the second axial edge 224 is a second beveled edge between 3-10° (angle 363) relative to the centerline 358.

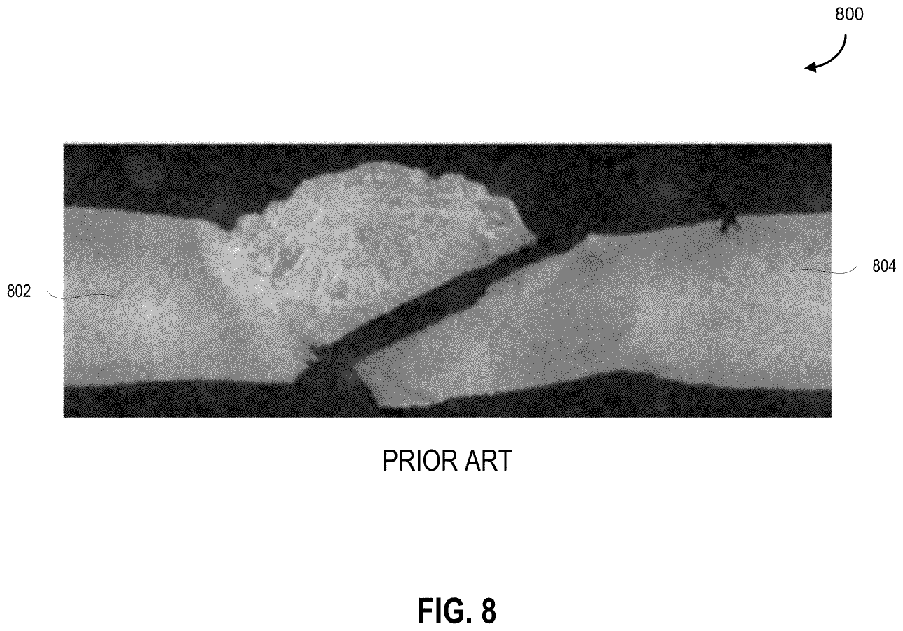

FIG. 8 is top view of a failed joint 800 of a prior art pipe having tubular sections 802, 804. The failed joint 800 was a weld formed in a wide angle groove, and is shown sheared at an inclination of approximating 45° to the pipe surface.

Narrowing the opening angle of the groove may increase the tensile strength and therefore avoid such undesirable structural failures.

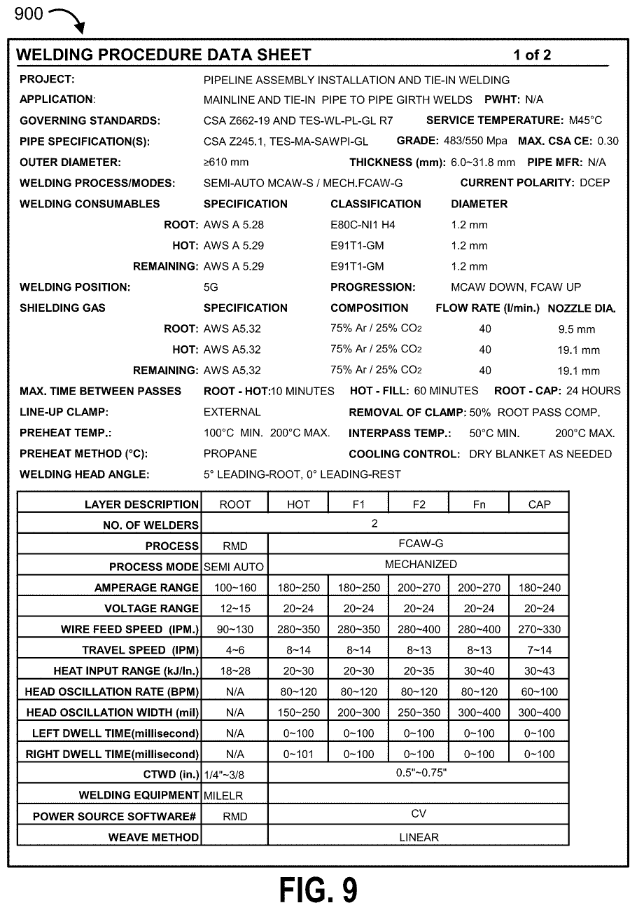

FIG. 9 is an exemplary Welding Procedure Specification (WPS) 900. This welding procedure specification describes a layered approach, including layers: Root, Hot, F1, F2, Fn, and CAP (see FIG. 5, for example). The WPS 900 can be utilized in a practical implementation of an example claimed embodiment, such as for pipeline assembly installation and tie-in welding for mainline and tie-in pipe to pipe girth welds.

Additional parameters and specifications are described to provide example parameters for a practical implementation, but Applicant notes that the claimed embodiments are not to be limited based on the specific parameters described herein as variation is possible and may depend on a specific weld context.

The proposed approach can thus be utilized to provide a weld that is used to join two pipes. After welding, the two pipe segments can be utilized, for example, in one string together, and a downstream approach can include inspecting each connection to meet safety and quality assurance requirements. For example, welds can be inspected using X-ray or ultrasonic processes to verify that each weld is sound and the pipeline is safe. The proposed approach herein can provide a pipeline join having improved technical characteristics for enhanced safety. The welded pipeline can be then be placed into a trench, backfilled/padded, and then entered into service following safety testing (e.g. integrity testing), any additional downstream processing steps.

Strong, high quality welds are a helpful mechanism to help ensure that pipelines remain a safe and environmentally friendly way to transport various materials, such as natural gas and petroleum. Downstream repair requirements are an additional feature that must be considered when considering the service life of a pipeline, and similarly, the improved repair characteristics of the proposed approaches described herein further contribute to increased safety and usefulness of the pipes during their service lives.

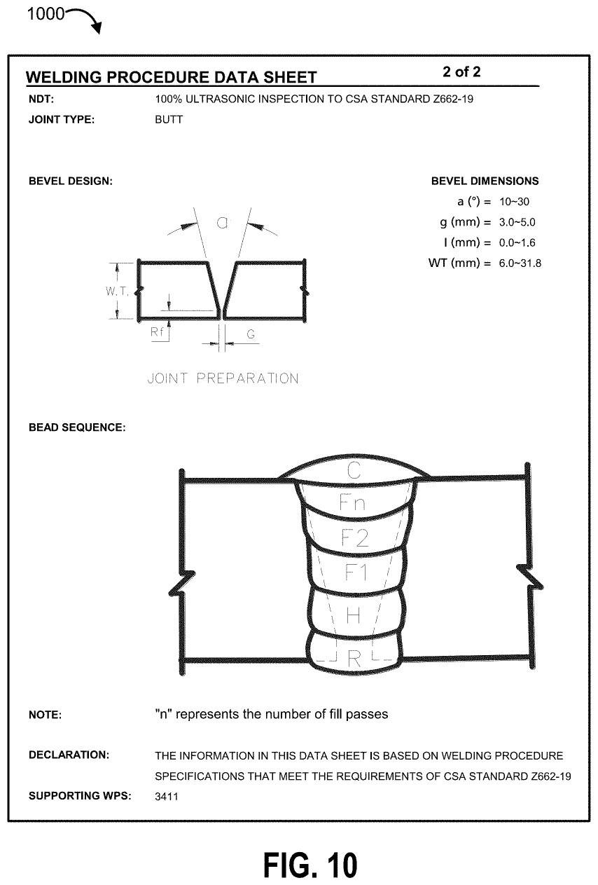

FIG. 10 is an additional sheet 1000 of an exemplary WPS, e.g. the WPS of FIG. 9.

In reference to FIGS. 9-10, WPS may be required as part of a certification process of the welding process under published standards, e.g. standards issued by the Canadian Standards Association or CSA Group. The exemplary WPS may be specific for welding two pipes together at respective axial ends, along their circumference or girth, i.e. a pipe to pipe girth weld. Such pipes may be part of a pipeline assembly. The welds may be used to form part of a mainline pipe or a tie-in pipe (a branch off of a pipeline portion). The dimensions and parameters shown in FIGS. 9-10 are selected such as to achieve improved mechanical properties compared to previous approaches while reducing costs and improving quality.

The welding consumables may be categorized according to where they are deposited: root, hot, remaining welding passes. For example, a root pass (e.g. single bead) may be overlain by a hot pass (e.g. single bead), followed by the remaining welding passes. In various embodiments, at least a root pass and a hot pass may be provided.

In some embodiments, the root pass consumable may be a seamless wire (metal-cored electrode), with classification E80C-NI1 H4, designed for welding low alloy steels with about 1% Ni deposit, and for applications where low temperature (impact) toughness may be required. In some example embodiments, the seamless wire may provide low moisture pick-up and weld metal hydrogen.

Table 1 shows weld metal analysis for welding the root pass consumable under various embodiments of shielding gas. In some example embodiments, shielding gas with composition 75% Ar/25% CO₂, at flow rate 40 l/min, with a nozzle diameter of 9.5 mm may be used.

In some embodiments, the diffusible hydrogen may be in the range 1.6-1.5 ml/100 g, e.g. as determined by gas chromatography. In some example embodiments, the “as welded” mechanical properties of such a root pass may include a tensile strength in the range 572-593 MPa, a yield strength in the range 544 MPa-496 MPa and an elongation percentage in 2″ (50 mm) in the range 25-27%, depending on the composition of the shielding gas.

In some example embodiments, the average Charpy V-Notch Impact Values of the root pass weld may vary in the range 60-84 ft lbs (81-114 Joules) at average temperatures of −45° C. (−50° F.), and 45-64 ft lbs (61-85 Joules) at averages temperatures of −60° C. (−76° F.), depending on the composition of the shielding gas.

TABLE 1

| Weld Metal | | |
|---|---|---|
| Analysis (%) | 95% Ar/5% O₂ | 80% Ar/20% CO₂ |
| Carbon (C) | 0.05 | 0.041 |
| Manganese (Mn) | 0.97 | 1.23 |
| Silicon (Si) | 0.44 | 0.50 |
| Phosphorus (P) | 0.005 | 0.005 |
| Sulphur (S) | 0.017 | 0.014 |
| Nickel (Ni) | 0.88 | 0.88 |
| Copper (Cu) | 0.11 | 0.11 |

In some embodiments, the hot pass or remaining pass consumable may be a flux-cored wire, e.g. adapted for high strength steels (such as Yield Strength 550 MPa steel). In some example embodiments, the hot pass or a remaining pass weld may comprise 0.05% Carbon (C), 0.33% Silicon (Si), 1.51% Manganese (Mn), 0.009% Phosphorus, 0.008% Sulphur (S), 0.95% Nickel (Ni), 0.16% Molybdenum (Mo), 0.055% Titanium (Ti), and 0.0037% Boron (B).

In some example embodiments, for an example weld with 80% Ar/20% CO₂ shielding gas provided at 25 l/min, the diffusible hydrogen content may vary in the range 2.9-3.3 ml/100 g (as determined by gas chromatography). In some example embodiments, for an example weld with 80% Ar/20% CO₂ shielding gas provided at 25 l/min, a 0.2% Proof Test is 611 MPa, tensile strength is 670 MPa, Elongation (EI) is 23%, and Reduction of Area (RA) of 68%. In various embodiments, for an example weld with 80% Ar/20% CO₂ shielding gas provided at 25 l/min, the Charpy absorbed energy may vary in the range 58-72 J at −60° C., 70-102 J at −50° C., and 91-96 J at −40° C. In some example embodiments, for an example weld with 80% Ar/20% CO₂ shielding gas provided at 25 l/min, the fraction appearance transition-temperature test (FATT) may yield temperatures below −60° C. In some example embodiments, shielding gas with composition 75% Ar/25% CO₂, at flow rate 40 l/min, with a nozzle diameter of 19.1 mm may be used.

In various embodiments, the example WPS may have other requirements or provisions, e.g. a re-qualification of the procedure or cut-out of the affected weld(s) if any essential changes exceeding those listed in CSA Z662-19 section 7 are made, or if any of the values for each pass on average fail under 20% or tighter tolerances.

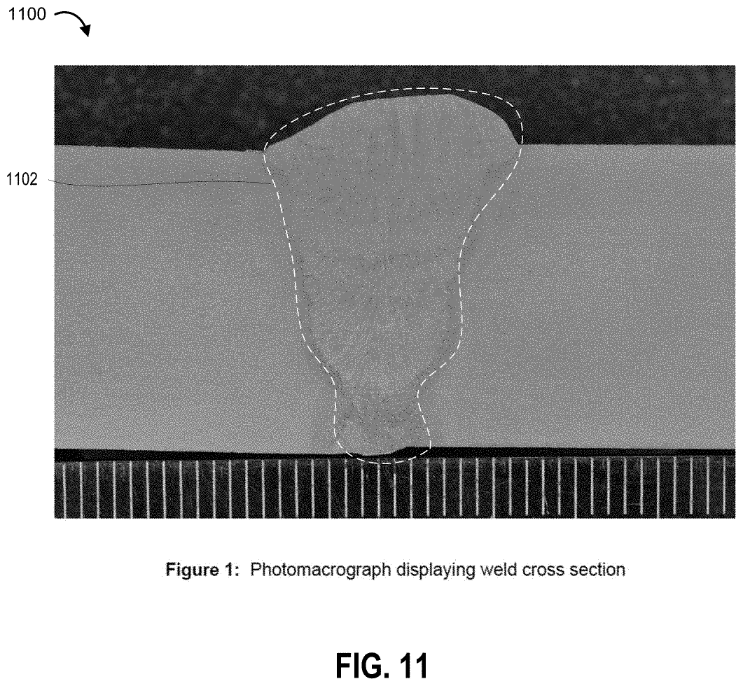

FIG. 11 is a photomacrograph of an exemplary weld cross-section 1100, etched using a 5% Nital etchant. The photomacrograph has a 2.5× magnification.

The region comprising the various weld passes is indicated enclosed by the dashed line 1102. The size is 508 mm (20.0 in.) outer diameter and 18.5 mm (0.728 in.) wall thickness.

The material is CSA Z245.1 Gr. 550. Such welds may be used to conduct various tests to qualify a welding procedure. Note, that in various embodiments, the narrow groove design may necessitate changing the contact tube to permit the welding torch to access the root of the groove. In some embodiments, the contact tube, gas nozzles and other welding components may need to be modified, e.g. if the current contact tube is too large to reach the root.

Table 2 provides tensile test results for two samples of an exemplary weld.

The governing specification for the test is CSA Z662-2019, and the test is carried out using a Tinius Olsen™ instrument, serial number 133680. The sample size is 508 mm (20.0 in.) outer diameter and 18.5 mm (0.728 in.) wall thickness.

The material is CSA Z245.1 Gr. 550. Such an exemplary weld may also be subjected to a side bend and nick break tests before qualification. The results in Table 2 may be used in qualifying or certifying an exemplary welding procedure.

TABLE 2

| | Sample T1 | | Sample T2 | |
|---|---|---|---|---|
| Width mm (in.) | 25.5 | (1.00) | 25.4 | (1.00) |
| Thickness mm (in.) | 18.2 | (0.717) | 18.3 | (0.718) |
| Area sq. mm (sq. in.) | 464 | (0.719) | 464 | (0.718) |
| Ultimate load N (lbf) | 319 217 | (71,800) | 320 964 | (72,200) |
| Ultimate stress MPa (psi) | 689 | (99,900) | 692 | (100,000) |

| | | |
|---|---|---|
| Fracture type | Partial Cup & Cone | Partial Cup & Cone |
| Fracture location | Parent Metal | Parent Metal |

Note:
Imperial values calculated by direct conversion.

Table 3 provides cross weld test results based on the specification ASME Section IX—2019. The test results may be obtained from a Satec™ instrument, serial number 1308, and an Epsilon™ Extensometer, serial number E94967.

The sample size is 508 mm (20.0 in.) outer diameter and 18.5 mm (0.728 in.) wall thickness.

The material is CSA Z245.1 Gr. 550.

The results in Table 3 may be used in qualifying or certifying an exemplary welding procedure.

TABLE 3

| Width mm (in.) | 19.0 | (0.749) |
|---|---|---|
| Thickness mm (in.) | 17.1 | (0.673) |
| Area sq. mm (sq. in.) | 325 | (0.504) |
| Gauge length mm (in.) | 50.8 | (2.00) |
| Yield strength method | 0.2% Offset | |
| Load at yield N (lbf) | 203 000 | (45,500) |
| Yield strength MPa (psi) | 623 | (90,300) |
| Yield strength method | 0.5% Extension Under Load | |
| Load at yield N (lbf) | 202 000 | (45,500) |
| Yield strength MPa (psi) | 623 | (90,300) |
| Ultimate load N (lbf) | 226 212 | (50,900) |
| Ultimate stress MPa (psi) | 696 | (101,000) |

| | |
|---|---|
| % Elongation | 28 |
| Type of fracture | Partial Cup & Cone |
| Location of fracture | Parent Metal |

Note:
Imperial values calculated by direct conversion.

Table 4 provides all-weld metal tensile test results based on the specification ASTM A370—19e1 & TES-WL-PL-GL Rev. 7. The test results may be obtained from a Satec™ instrument, serial number 1308, and an Epsilon™ Extensometer, serial number E99163. The sample size is 508 mm (20.0 in.) outer diameter and 18.5 mm (0.728 in.) wall thickness. The material is CSA Z245.1 Gr. 550. The results in Table 4 may be used in qualifying or certifying an exemplary welding procedure.

TABLE 4

| Diameter mm (in.) | 6.39 | (0.252) |
|---|---|---|
| Area sq. mm (sq. in.) | 32.1 | (0.050) |
| Gauge length mm (in.) | 25.4 | (1.00) |
| Yield strength method | 0.2% Offset | |
| Load at yield N (lbf) | 20 700 | (4,650) |
| Yield strength MPa (psi) | 645 | (93,500) |
| Ultimate load N (lbf) | 22 580 | (5,080) |
| Ultimate stress MPa (psi) | 704 | (102,000) |
| Final area sq. mm (sq. in.) | 12.2 | (0.019) |

| | |
|---|---|
| % Reduction of area | 62 |
| % Elongation | 26 |
| Type of fracture | Partial Cup & Cone |

Note:
Imperial values calculated by direct conversion.

Tables 5 and 6 provide Charpy V-notch impact tests according to the specification ASTM E23-2018 & TES-WL-PL-GL Rev. 7, for a specimen of 10×10 mm (0.394×0.394 in.) in a transverse orientation.

The test results are obtained using a Satec™ S-1 K3 instrument, serial number 1503, with a 407 J (300 ft Ibf) capacity, and a verified range of 3.4 and −137 J (2.5-101 ft Ibf). The sample size is 508 mm (20.0 in.) outer diameter and 18.5 mm (0.728 in.) wall thickness. The material is CSA Z245.1 Gr. 550.

The results in table 5 are at a test temperature of −5° C. (23° F.) and the results in table 6 are at −45° C. (−49° F.). The results in Tables 5 and 6 may be used in qualifying or certifying an exemplary welding procedure.

TABLE 5

| | | | | | Lateral |
|---|---|---|---|---|---|
| Specimen | | Impact Values | | Shear | Expansion |
| Number | Notch Location | J | (ft · lbf) | % | in. |
| F2.1 | Weld Metal within 1.5 | 121 | 89 | 90 | 0.055 |
| F2.2 | mm from root surface | 103 | 76 | 83 | 0.06 |
| F2.3 | | 106 | 78 | 89 | 0.061 |
| F3.1 | HAZ within 1.5 mm | >137 | (>101) | 81 | 0.092 |
| F3.2 | from cap surface | >137 | (>101) | 75 | 0.073 |
| F3.3 | | >137 | (>101) | 80 | 0.073 |

Note:
Metric values calculated by direct conversion.

TABLE 6

| | | | | | Lateral |
|---|---|---|---|---|---|
| Specimen | | Impact Values | | Shear | Expansion |
| Number | Notch Location | J | (ft · lbf) | % | in. |
| G2.1 | Weld Metal within | 79 | −58 | 85 | 0.048 |
| G2.2 | 1.5 mm from root | 76 | −56 | 81 | 0.043 |
| G2.3 | surface | 83 | −61 | 81 | 0.05 |
| G3.1 | HAZ within 1.5 | >137 | (>101) | 71 | 0.102 |
| G3.2 | mm from cap | >137 | (>101) | 71 | 0.09 |
| G3.3 | surface | >137 | (>101) | 76 | 0.097 |

Note:
Metric values calculated by direct conversion.

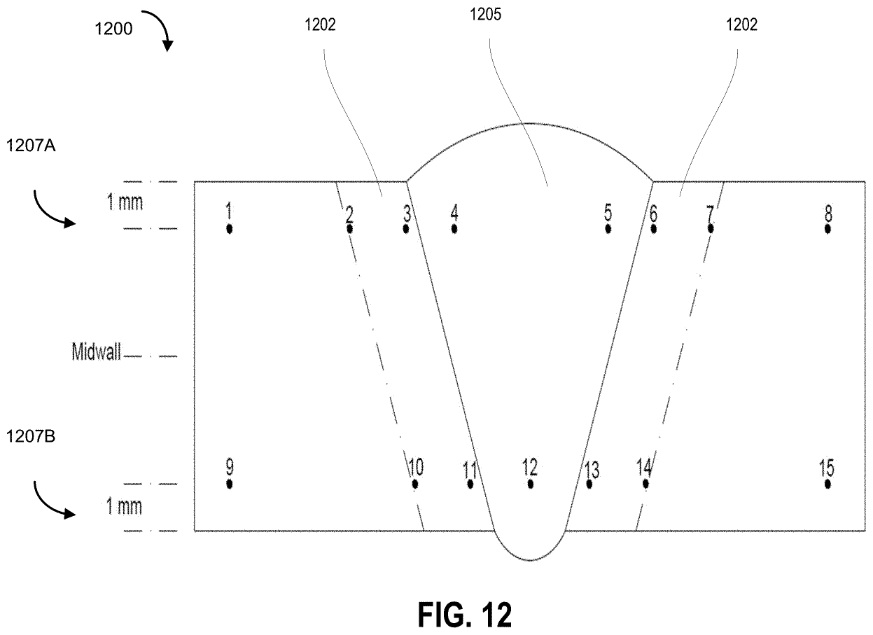

FIG. 12 is a schematic of exemplary welded pipes 1200 marked with testing positions for hardness testing, specifically Vickers 1 kg (HV1) hardness tests.

The testing positions comprise a first row 1207A and a second row 1207B that extended across the heat affected zone (HAZ) 1202 around the weld 1205 itself.

The first row 1207A comprises positions labeled 1 through 8, and is offset 1 mm radially inwardly from the outer diameter (OD) surface.

The second row 1207B comprises positions labeled 9 through 15, and is offset 1 mm radially outwardly from the inner diameter (ID) surface.

Tables 7 and 8 show test results from Vickers 1 kg (HV1) hardness tests, based on the ASTM E92—17 & TES-WL-PL-GL Rev. 7 specification. The tests are carried out using a Durascan™ 70 instrument.

The hardness at various positions is indicated.

The sample size is 508 mm (20.0 in.) outer diameter and 18.5 mm (0.728 in.) wall thickness.

The material is CSA Z245.1 Gr. 550.

The positions are the same as shown in FIG. 12.

The positions may lie in the parent pipes (“parent”), the heat-affect zones (HAZ), or the weld (“Weld”) itself.

The results in Tables 7 and 8 may be used in qualifying or certifying an exemplary welding procedure.

TABLE 7

| Position | Hardness | Position type |
|---|---|---|
| 1 | 244 | Parent |
| 2 | 233 | HAZ |
| 3 | 247 | HAZ |
| 4 | 230 | Weld |
| 5 | 244 | Weld |
| 6 | 276 | HAZ |
| 7 | 234 | HAZ |
| 8 | 264 | Parent |

TABLE 8

| Position | Hardness | Position type |
|---|---|---|
| 9 | 238 | Parent |
| 10 | 261 | HAZ |
| 11 | 254 | HAZ |
| 12 | 214 | Weld |
| 13 | 254 | HAZ |
| 14 | 247 | HAZ |
| 15 | 257 | Parent |

Table 9 provides a comparison of Charpy V-Notch (CVN) impact values of an exemplary weld embodiment compared to results from previous approaches, for two different temperatures.

The results illustrate an aspect of the efficacy of some embodiments, and in particular, a much higher CVN value is noted for some embodiments.

TABLE 9

| Weld Procedure | CVN (J) at −45° C. | CVN (J) at −5° C. |
|---|---|---|
| 3249 (previous) | 40.6 | — |
| 3250 (previous) | 31.2 | — |
| 3251 (previous) | 36.6 | — |
| 3252 (previous) | 16.3 | 62.4 |
| 3361 (previous) | 15 | — |
| 3257 (previous) | 24 | 83 |
| 3258 (previous) | 22 | 83 |
| 3259 (previous) | 24 | 86 |
| 3266 (previous) | 31 | — |
| 3327 (previous) | 16 | 95 |
| 3366 (previous) | 19 | 73 |
| 3399 (previous) | 15 | 64 |
| 3411 (exemplary weld) | 76 | 103 |

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As will be appreciated from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the embodiments described herein are intended to include within their scope such processes, machines, manufacture, compositions of matter, means, methods, or steps.

As can be understood, the examples described above and illustrated are intended to be exemplary only. The foregoing discussion provides many example embodiments of the example subject matter. Although each embodiment represents a single combination of elements, the subject matter is considered to include all possible combinations of the disclosed elements. Thus if one embodiment comprises elements A, B, and C, and a second embodiment comprises elements B and D, then the subject matter is also considered to include other remaining combinations of A, B, C, or D, even if not explicitly disclosed.

What is claimed is:

1. A method of manufacturing a pipe by joining a first tubular section to a second tubular section along a pipe axis, the first and second tubular sections having substantially similar inside and outside diameters, the method comprising:
forming a weld between the first tubular section and the second tubular section by depositing weld material under heat to substantially fill a root at a radially inner end of a welding gap formed between the first tubular section and second tubular section;
wherein the welding gap extends from a radially inner wall of the pipe to a radially outer wall of the pipe, the root axially spaces the first tubular section apart from the second tubular section substantially between approximately 1 mm and approximately 6 mm; and
wherein the welding gap is formed by positioning a first axial edge defined by the first tubular section axially alongside a second axial edge defined by the second tubular section, the first and second axial edges angled substantially between approximately 6° to approximately 20° away from each other radially outwardly to form a portion of the welding gap radially outward relative to the root.

2. The method of claim 1 wherein the root radially extends less than approximately 3 mm from the radially inner wall of the pipe.

3. The method of claim 1, wherein a radial length of the welding gap is substantially between approximately 6 mm and approximately 50 mm.

4. The method of claim 1, wherein the weld is a first weld, and further comprising:
forming one or more additional welds by depositing additional weld material under heat to fill the welding gap, the one or more additional welds including a second weld formed over the first weld.

5. The method of claim 4, wherein each of the one or more additional welds is a single bead weld extending axially in the welding gap from the first tubular section to the second tubular section.

6. The method of claim 5, wherein the first axial edge extends circumferentially along the first tubular section around the pipe axis and the second axial edge extends circumferentially along the second tubular section around the pipe axis, such that the welding gap extends circumferentially around the pipe axis between the first and second tubular sections, the first weld and each of the one or more additional welds extending circumferentially around the welding gap.

7. The method of claim 1, wherein the root axially spaces the first tubular section apart from the second tubular section between substantially approximately 3 mm and approximately 6 mm.

8. The method of claim 1, wherein the weld is formed free of a weld backing at a radial opening defined by the welding gap.

9. The method of claim 1, wherein the weld material is deposited into the root of the welding gap from a consumable electrode.

10. The method of claim 1, wherein a centerline of the welding gap extends radially through the root, the first axial edge is a first beveled edge angled between approximately 3-approximately 10° relative to the centerline and the second axial edge is a second beveled edge between 3-10° relative to the centerline.

11. A joint between a first tubular section and a second tubular section of a pipe, the first and second tubular sections having substantially similar inside and outside diameters, the joint comprising:
a welding groove having an open-ended profile extending from a radially inner wall of the pipe to a radially outer wall of the pipe, the welding groove at least partially formed between a first axial edge defined by the first tubular section and a second axial edge defined by the second tubular section, the welding groove including:
a root formed at a radially inner end of the welding groove; and
a portion of the welding groove radially outward relative to the root; and
a welding bead filling the root between the first and second tubular sections and formed by depositing weld material in the root under heat,
wherein the root is configured to, prior to formation of the welding bead, axially space the first tubular section apart from the second tubular section substantially between 1 mm and 6 mm; and
wherein the first and second axial edges, prior to formation of the welding bead, are angled substantially between 6-20° away from each other radially outwardly to form the portion.

12. The joint of claim 11, wherein the root, prior to formation of the welding bead, radially extends less than 3 mm from the radially inner wall of the pipe, and an axial width of the welding groove spacing the first tubular section from the second tubular section is non-decreasing radially outwardly from the root.

13. The joint of claim 11, wherein a radial length of the welding groove is substantially between 6 mm and 50 mm.

14. The joint of claim 11, wherein the welding bead is a first welding bead, the joint further comprising:
one or more additional welding beads formed over the first welding bead and filling the welding groove, the one or more additional welds including a second welding bead formed over the first welding bead.

15. The joint of claim 14, wherein each of the one or more additional welding beads extends axially in the welding gap from the first tubular section to the second tubular section.

16. The joint of claim 15, wherein the first axial edge extends circumferentially along the first tubular section around a pipe axis and the second axial edge extends circumferentially along the second tubular section around the pipe axis such the welding groove extends circumferentially around the pipe axis between the first and second tubular sections, the first welding bead and each of the one or more additional welds extending circumferentially around the welding gap.

17. The joint of claim 11, wherein the root is configured to, prior to formation of the welding bead, axially space the first tubular section apart from the second tubular section substantially between 1 mm and 4 mm.

18. The joint of claim 11, wherein the welding groove is free from a weld backing at a radial opening of the welding groove.

19. A pipe assembly, comprising:
a first tubular section;
a second tubular section configured to couple with the first tubular section along a pipe axis;
a welding groove having an open-ended profile circumferentially extended around the pipe axis and radially extended between a radially inner wall of the pipe assembly and a radially outer wall of the pipe assembly, the welding groove at least partially formed between a first axial edge defined by the first tubular section and a second axial edge defined by the second tubular section, the welding groove including
a root formed at a radially inner end of the welding groove and configured to receive a welding bead filling the root between the first and second tubular sections to create a joint between the first and second tubular sections, the welding bead configured to be formed by depositing weld material in the root under heat; and
a portion of the welding groove radially outward relative to the root and configured to receive one or more additional welding beads formed over the first welding bead and filling the welding groove, the one or more additional welds including a second welding bead configured to be formed over the first welding bead;
wherein the root axially spaces the first tubular section apart from the second tubular section substantially between 1 mm and 6 mm; and
wherein the first and second axial edges are angled substantially between approximately 6° to approximately 20° away from each other radially outwardly to form the portion of the welding groove.

20. The pipe assembly of claim 19, wherein the welding bead is configured to be formed without a weld backing.
